(19) United States
(12) Patent Application Publication
(10) Pub. No.: US 2016/0300511 A1
(43) Pub. Date: Oct. 13, 2016

(54) FOLDABLE CARD

(71) Applicant: Blythe Ratzmann, Germantown, WI (US)

(72) Inventor: Blythe Ratzmann, Germantown, WI (US)

(21) Appl. No.: 14/681,407

(22) Filed: Apr. 8, 2015

(51) Int. Cl. G09F 1/06; G06F 17/50; B42D 15/04

(52) U.S. Cl. CPC G09F 1/06; B42D 15/042; G06F 17/50

(57) ABSTRACT

A foldable card includes a plurality of triangles connected side-to-side in a planar material, foldable into a hexaflexagon. The card includes a first set of six triangles forming a first face in a first flexed orientation of the hexaflexagon, a second set of six triangles forming a second face in a second flexed orientation of the hexaflexagon, and a third set of six triangles forming a third face in a third flexed orientation of the hexaflexagon. Print on the planar material is selectively oriented on triangles of the first, second, and third sets, such that, when flexed subsequently from the first, to the second, and then to third flexed orientations, a story is progressively conveyed to a user on each of the first, second, and third faces.

### FIELD OF TECHNOLOGY

This disclosure relates generally to greetings cards, story-telling devices, instructional cards, and the like, that are placed on a hexaflexagon.

### BACKGROUND

A hexaflexagon, known in the art, has changeable faces that may be manipulated to present a six-sided polygon. Typically, a plurality of triangular elements are hinged in such a fashion that, when folded together, a first set of 6 triangles is facing toward a user. The user then rearranges the faces by “flexing” to the next polygonal arrangement, to present a next set of triangles to the user. The arrangement may be flexed yet again, presenting yet another set of triangles to the user.

Known hexaflexagons include a 3-flex or 3-combination arrangement and a 6-combination arrangement, as examples. In the 3-flex arrangement, faces may be flexed from a first, to a second, and then to a third face. Another flex then rearranges the triangles back to the first face. In the 6-flex or 6-combination arrangement, flexing progresses through first, second, and third faces, then back to the first, by following a progressive pattern through the three faces and back to the first. However, in the 6-flex arrangement, alternate face options derive from each of the first, second, and third faces if the arrangement is flexed in an alternate direction. That is, fourth, fifth, and sixth faces are also available for a total of 6 faces. One known application includes making a gameboard from a hexaflexagon, and flexing between faces to present different combinations of triangles to a user to obtain different game boards.

Typically, hexaflexagons are fabricated using a pattern of triangles drawn on a sheet of paper. The paper is cut around the perimeter of the pattern, and folded to form the hexaflexagon. Once appropriately folded, the patterns may be progressively viewed by flexing through the progression of faces, as described. Such devices are known in the art and have been improved upon in a variety of fashions. For instance, one known improvement includes using a bonding material between the triangular elements to reduce the amount of wear that occurs in the flexing process. Another known improvement includes laminating the triangles together such that the laminate between the triangles acts as a hinge, reducing the propensity for tearing at the boundaries between the triangles.

However, the known applications are not practical for greeting cards, story-telling devices, and the like.

### BRIEF DESCRIPTION

Embodiments are directed toward greetings cards, story-telling devices, instructional cards, and the like, that are placed on a hexaflexagon.

According to one aspect, a foldable card includes a plurality of triangles connected side-to-side in a planar material, foldable into a hexaflexagon. The card includes a first set of six triangles forming a first face in a first flexed orientation of the hexaflexagon, a second set of six triangles forming a second face in a second flexed orientation of the hexaflexagon, and a third set of six triangles forming a third face in a third flexed orientation of the hexaflexagon. Print on the planar material is selectively oriented on triangles of the first, second, and third faces, such that, when flexed subsequently from the first, to the second, and then to third flexed orientations, a story is progressively conveyed to a user on each of the first, second, and third faces.

According to another aspect, a method of forming a foldable card includes receiving text for a story, placing portions of the text in triangles and in a pattern such that when the pattern is printed onto a sheet of paper, the paper is foldable into a hexaflexagon. The card includes a first set of six triangles forming a first face in a first flexed orientation of the hexaflexagon, a second set of six triangles forming a second face in a second flexed orientation of the hexaflexagon, and a third set of six triangles forming a third face in a third flexed orientation of the hexaflexagon. The portions of text are selectively oriented on triangles of the first, second, and third sets, such that, when flexed subsequently from the first, to the second, and then to third flexed orientations, the story is progressively conveyed to a user on each of the first, second, and third faces.

According to another aspect, a computer readable storage medium having stored thereon a computer program comprising instructions, which, when executed by a computer, cause the computer to receive text for a story, and place portions of the text in triangles and in a pattern such that when the pattern is printed onto a sheet of paper, the paper is foldable into a hexaflexagon. The card includes a first set of six triangles forming a first face in a first flexed orientation of the hexaflexagon, a second set of six triangles forming a second face in a second flexed orientation of the hexaflexagon, and a third set of six triangles forming a third face in a third flexed orientation of the hexaflexagon. The portions of text are selectively oriented on triangles of the first, second, and third faces, such that, when flexed subsequently from the first, to the second, and then to third flexed orientations, the story is progressively conveyed to a user on each of the first, second, and third faces.

According to yet another aspect, a foldable card includes a plurality of triangles connected side-to-side in a planar material, folded into a hexagonally shaped hexaflexagon. The card includes print on the planar material that is selectively oriented on triangles of first, second, and third sets of triangles, such that, when flexed subsequently from first, to second, and then to third flexed orientations, a story is progressively conveyed to a user on each of first, second, and third faces that correspond with the respective first, second, and third flexed orientations.

Various other features and advantages will be made apparent from the following detailed description and the drawings.

### BRIEF DESCRIPTION OF THE DRAWINGS

FIG. 1 is a top and bottom view of a planar material for formation of a 3-flex hexaflexagon with illustrated orientation of triangular faces.

FIG. 2A illustrates the 3-flex hexaflexagon of FIG. 1 in its unfolded state.

FIG. 2B illustrates the 3-flex hexaflexagon of FIG. 1 after its first fold.

FIG. 2C illustrates the 3-flex hexaflexagon of FIG. 1 after its second fold.

FIG. 2D illustrates the 3-flex hexaflexagon of FIG. 1 after its third fold.

FIG. 3 illustrates progression of faces of the 3-flex hexaflexagon of FIG. 1 as it progresses through first, second, and third flexed orientations.

FIG. 4A illustrates a first face of the 3-flex hexaflexagon of FIG. 1 in a first flexed orientation.

FIG. 4B illustrates a second face of the 3-flex hexaflexagon of FIG. 1 in a second flexed orientation.

FIG. 4C illustrates a third face of the 3-flex hexaflexagon of FIG. 1 in a third flexed orientation.

FIG. 5A illustrates a face of the 3-flex hexaflexagon of FIG. 1 having text that begins at an outer edge and progresses toward a center.

FIG. 5B illustrates a 6^{th} triangle on a flexed face having exemplary instructions to proceed to the next page or flexed position.

FIG. 6 illustrates a face of the 3-flex hexaflexagon of FIG. 1 having text that is approximately orthogonal to its center.

FIG. 7 illustrates progression of faces of a 6-flex hexaflexagon of FIG. 1 as it progresses through its 6 flex options.

### DETAILED DESCRIPTION

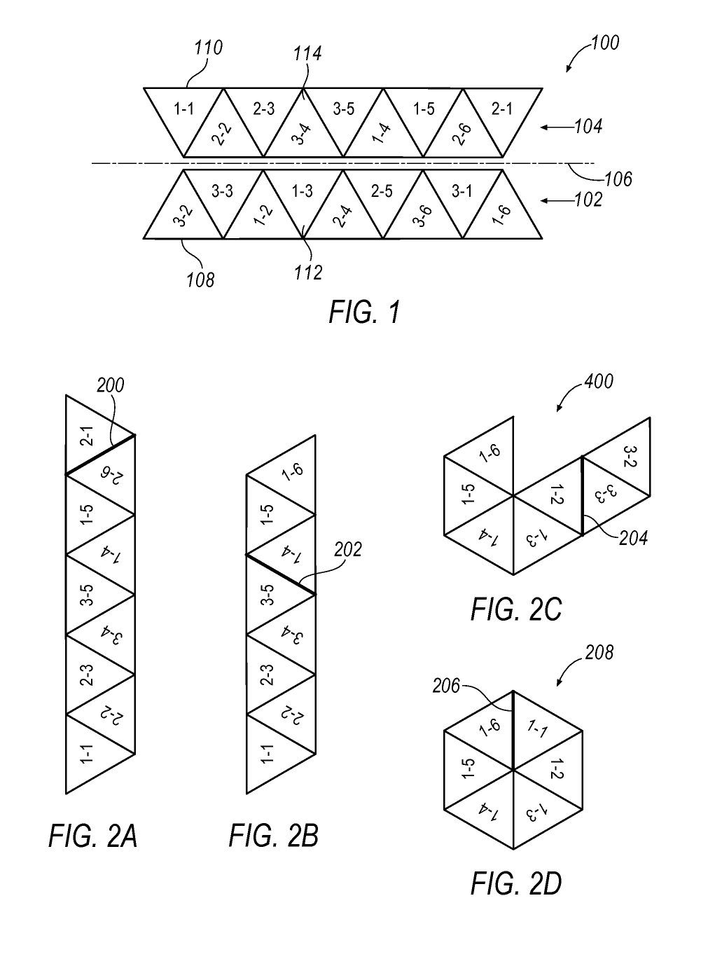

FIG. 1 is a top and bottom view of a planar material 100 for formation of a 3-flex hexaflexagon with illustrated orientation of triangular faces, according to one exemplary embodiment. Planar material 100 includes a first surface 102 and a second surface 104. The two surfaces illustrated are separated by a line 106. First and second surfaces 102, 104 illustrate, in one example, top and bottom surfaces of the same sheet of paper in orientation to one another with respect to the centerline. The triangles illustrated correspond to the triangles that will later be shown in their proper orientation within a hexaflexagon. That is, the top and bottom each show a pattern that, as will be described, not only results in a hexaflexagon, but results in a known orientation of triangular faces that may be taken advantage of, as will be further described.

As one example, a first triangular face 108 is illustrated having the numbers “3-2” therein, and oriented as shown. On the opposite side of first triangular face 108 is a second triangular face 110 which, when flipped about line 106, has the numbers “1-1” therein (hereinafter dashed face numbers will be referenced without accompanying quotation marks, although such are not to be confused with element numbers referenced in the Figures). Each triangle, thereby, includes respective numbers therein which, as will be illustrated, are folded to form a hexaflexagon according to an embodiment. As examples, a triangular face 112 having 1-3 therein corresponds to its opposite side 114 that includes 3-4 therein. Accordingly, a total of 9 triangles are included, each having two surfaces (top and bottom), for a total of 18 triangular surfaces.

The 18 triangular surfaces have 3 sets of 6 triangles that include:

a first set: 1-1; 1-2; 1-3; 1-4; 1-5; 1-6;

a second set: 2-1; 2-2; 2-3; 2-4; 2-5; 2-6; and

a third set: 3-1; 3-2; 3-3; 3-4; 3-5; 3-6.

Each set therefore represents what will correspond to first, second, and third faces of a finished hexaflexagon as it is flexed through first, second, and third flexed orientations.

FIGS. 2A-2D illustrate steps of folding planar material 100 to form the 3-flex hexaflexagon. FIG. 2A illustrates the planar material 100 of FIG. 1 used to form a 3-flex hexaflexagon in its unfolded state. FIG. 2A illustrates a first folded crease that is between faces 2-1 and 2-6.

FIG. 2B illustrates the 3-flex hexaflexagon of FIG. 2A after its first fold at crease 200. Thus, face 2-1 is no longer visible as it has been folded on top of face 2-6, showing face 1-6 that was previously on the underside. FIG. 2B also shows a crease 202 that is folded from the underside (as illustrated), causing 5 triangle faces in FIG. 2B (3-5, 3-4, 2-3, 2-2, and 1-1) to fold underneath, resulting in FIG. 2C. Accordingly, referring to FIG. 2C, faces 1-3, 1-2, 3-3, and 3-2, previously on the underside, are facing up. FIG. 2C also shows a crease 204. Faces 3-3 and 3-2 are turned down about crease 204, turning up face 1-2 from the underside. Faces 1-1 and 1-6 are joined at a boundary 206 to form a hexaflexagon 208.

Accordingly, FIGS. 2A-2D illustrate an exemplary set of steps that may be used to form a hexaflexagon. Also, although hexaflexagon is described as having been formed by a single planar material or sheet of paper having triangular face numbers on top and bottom, it is contemplated that two sheets of paper may be printed having a pattern, such as described, which may then be adhered on the back side and then folded to form the hexaflexagon. Further, it is also contemplated that, although a planar material (such as a single sheet of paper) is described as used to form the hexaflexagon, it is contemplated that individual triangles, or blocks of triangles, may be first printed on front and back, and then joined together with tape, and the like. Thus, the disclosed planar material 100 is but one example of how to form a hexaflexagon, according to the disclosure.

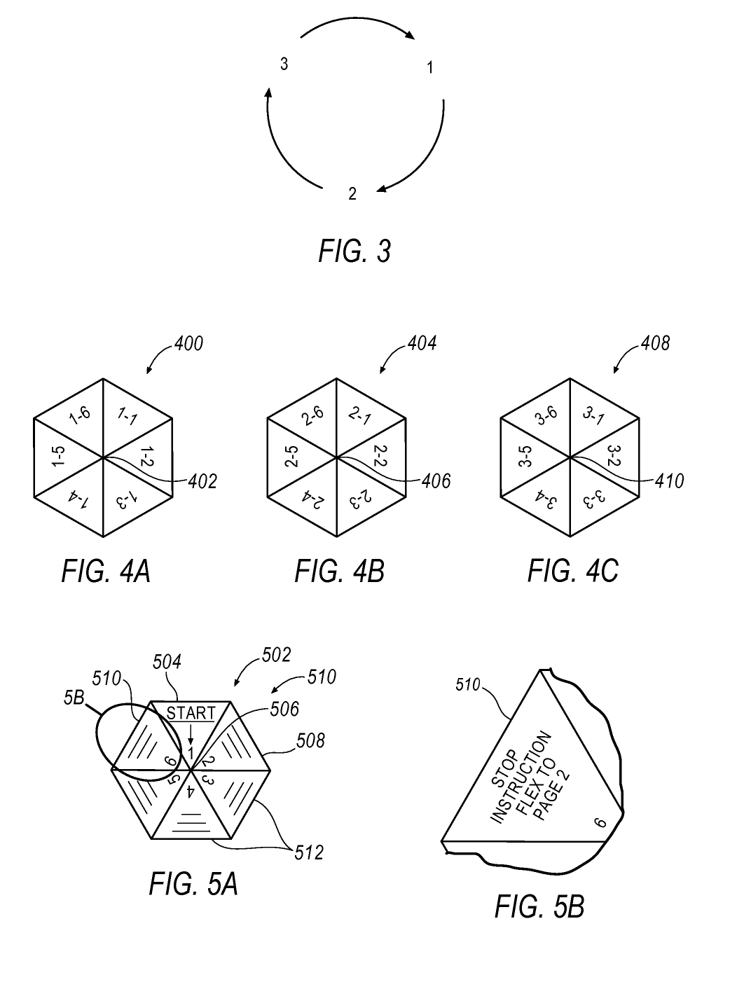

FIG. 3 illustrates progression of faces of the 3-flex hexaflexagon of FIG. 1 as it progresses through first, second, and third flexed orientations. That is, a first face (having triangles 1-1, 1-2, 1-3, 1-4, 1-5, and 1-6) is formed according to the description corresponding to FIGS. 2A-2D. The hexaflexagon is thereby “flexed” by folding one of the boundaries back on itself, and in a multi-step process the second face (having triangles 2-1, 2-2, 2-3, 2-4, 2-5, and 2-6) is revealed. Subsequently, the faces are flexed in the same fashion, resulting in the third face (having triangles 3-1, 3-2, 3-3, 3-4, 3-5, and 3-6) being revealed. Accordingly, a pattern of exposed faces following faces 1, then 2, then 3 results.

The orientation of the faces is for each face 1, 2, and 3 is shown in FIGS. 4A, 4B, and 4C. Referring first to FIG. 4A, a first face 400 includes triangles having faces 1-1, 1-2, 1-3, 1-4, 1-5, and 1-6, and each is properly oriented with respect to a center 402. Likewise, FIG. 4B shows a second face 404 that includes having faces 2-1, 2-2, 2-3, 2-4, 2-5, and 2-6 also properly oriented with respect to its respective center 406. Similarly, FIG. 4C shows a third face 408 that includes having faces 3-1, 3-2, 3-3, 3-4, 3-5, and 3-6 also properly oriented with respect to its respective center 410.

Thus, FIGS. 4A-4C show orientation of faces 400, 404, and 408, as they result from the pattern shown in FIG. 1. That is, each of the triangular faces is oriented in the same fashion toward the respective center 402, 406, and 410, based on the pattern of top and bottom from FIG. 1.

As such, a foldable card is formed that includes a plurality of triangles connected side-to-side in a planar material, and foldable into a hexaflexagon. The card includes a first set of six triangles forming a first face in a first flexed orientation of the hexaflexagon, a second set of six triangles forming a second face in a second flexed orientation of the hexaflexagon, and a third set of six triangles forming a third face in a third flexed orientation of the hexaflexagon.

Thus, given the known orientation of triangular faces that result from the pattern used in FIG. 1, text may be included in lieu of the numbers shown, such that the card may be formed having properly oriented text within each of the triangles. Accordingly, text may be included in each of the triangles that may correspond to a story or other text. The story may include, as examples, a fictional narrative, a non-fictional narrative, or a greeting for a greeting card. It is contemplated, however, that any narrative may be included, and not limited to that disclosed, and all references to the term “story” broadly encompasses any text that may be used to convey information. Accordingly, a hexaflexagon as disclosed herein may be given as a present, or to accompany a present, or to provide instructions for a treasure hunt, or for instructions in a workplace environment, as examples.

Referring to FIG. 5A, a face 500 (corresponding to the first face of FIG. 4A, as an example), includes triangles numbered 1-6. A first triangle 502, may include a first portion of a story and may even begin with an indication to “start here” or “start” 504. A user or reader reads down within the first triangular face, and then turns face 500 about its center 506 (formed at an apex of the 6 triangles), yielding second triangle 508 in an orientation that is now favorable for the reader. After reading the text within all triangles 1-6 during subsequent partial rotations of face 500 about center 506, a last triangle 510 (illustrated in FIG. 5B) may include instructions to, for instance stop (i.e., to open a gift in the event of a greeting card, which may accompany the card), open the gift (or perform some other function as instructed to do), before flexing to the next page.

As such, first face 500 may include a pleasant or humorous story that a user can enjoy by first reading through the first 6 triangles, following some instruction, and then flexing to the second face. Thus, the disclosure includes print on a planar material that is selectively oriented on triangles of first, second, and third faces, such that, when flexed subsequently from the first, to the second, and then to third flexed orientations, a story is progressively conveyed to a user on each of the first, second, and third faces. The first face includes a center at the apex of the first set of six triangles, and the story progresses from a beginning to a first sub-ending, on the first face. First, the user orients the first face such that the story is discernible to the user on the first triangle of the first set of triangles, and the user then rotates the first face about the center such that, at subsequent rotational orientations of the first face, the story progresses to the first sub-ending. The story progresses on the second face, and then an instruction again in a triangle at the end of the second face instructs the user to flex to the third face. As such, there are three flexed orientations in the disclosed embodiment of FIG. 1. Upon flexing to the second flexed orientation and then to the third flexed orientation, the story progresses on the second face and on the third face when the user rotates respectively about each respective center.

As shown in FIG. 5A, the print is oriented on each triangle such that the story begins from an outer edge 512 of first face 500, and progresses toward center 506.

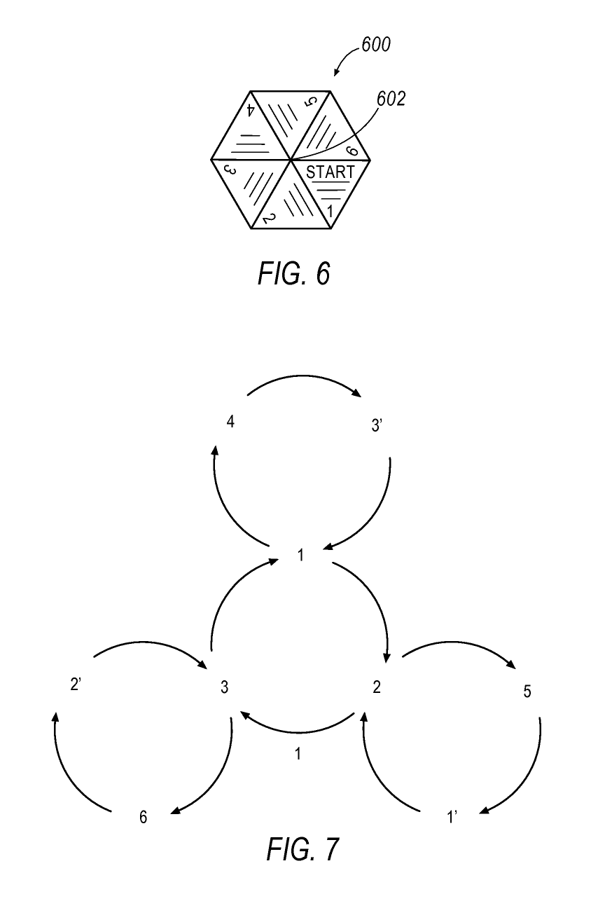

However, in another exemplary embodiment illustrated in FIG. 6, text of the disclosed story may be illustrated orthogonal to that disclosed, wherein the print is oriented on each triangle such that text of the story is approximately orthogonal to each respective center. Thus, a face 600 may include a center 602, however in this example the text may be oriented approximately orthogonal to the respective center 602. Further, it is contemplated that within one hexaflexagon multiple face combinations may be employed. For example, a first face may have text oriented such that a reader reads from an outer edge to a center, and a second face may have text that results (based on the pattern, changed accordingly), for only the second face, such that is text is orthogonal to the center of the second face. In fact, any combination or orientations may be employed, according to the disclosure. Accordingly, text in each of the triangles as illustrated in FIG. 1 may be appropriately rotated such that the text is at the desired orientation in the final folded card, and in each flexed orientation.

The story may include any number of creative progressions. For instance, in one example, the story may include on the first face and in the first flexed orientation, a beginning of the story on a first triangle of a first set of six triangles, and a first sub-ending on a second triangle of the first set of six triangles (resulting in an instruction to open a gift, perform a function, and/or flex to the next face). On the second face and in the second flexed orientation, the story continues from the first sub-ending and on a first triangle of the second set of six triangles. A second sub-ending of the story is included on a second triangle of the second set of six triangles. On the third face and in the third flexed orientation a second continuation of the story, from the second sub-ending, and on a first triangle of the third set of six triangles. A third sub-ending of the story is on a second triangle of the third set of six triangles.

In addition, it is contemplated that the disclosure may be implemented in a 6-flex design as well. As shown in FIG. 7, a 6-flex design may include progression through faces that include a first, second, and third face. However, each of these “primary” faces includes their own sequence of faces. For instance, face 1 may progress not only to face 2, but may also progress to a fourth face, and then through another face designated as 3′. That is, triangles for face 4 may be selectively oriented such that face 4 may also include a part of the story as it progresses in faces 1, 2, and 3. However, after progressing to face 4, face 3′ shows in a subsequent flex in which the triangles of face 3 are re-oriented in a fashion different from face 3. Similarly, face 2 may flex not only to face 3, but also to face 5 and then to face 1′ which, as with 3′, includes the triangles of face 1 but in an undesired orientation. Likewise, face 3 may flex not only to face 1, but also to face 6 and then to face 2′ which includes the triangles of face 2 but in an undesired orientation.

Disclosed herein also is a computer program that may be used to generate a correct pattern and orientation of triangles, such that a story may be generated (i.e., using a keyboard or by importing text) that may be then re-arranged to generate the hexaflexagon according to the desire of a user. Thus, according to one embodiment, a user may employ a computer program that causes the computer to receive text for a story, and place portions of the text in triangles and in a pattern such that when the pattern is printed onto a sheet of paper. The paper is foldable into a hexaflexagon, and the card includes a first set of six triangles forming a first face in a first flexed orientation of the hexaflexagon, a second set of six triangles forming a second face in a second flexed orientation of the hexaflexagon, and a third set of six triangles forming a third face in a third flexed orientation of the hexaflexagon. The portions of text are selectively oriented on triangles of the first, second, and third sets, such that, when flexed subsequently from the first, to the second, and then to third flexed orientations, the story is progressively conveyed to a user on each of the first, second, and third faces. The first face includes a center at an apex of the first set of six triangles, and the story progresses from a beginning to a first sub-ending, on the first face. In one example, the user orients the first face such that the story is discernible to the user on the first triangle of the first set of triangles, and the user rotates the first face about the center such that, at subsequent rotational orientations of the first face, the story progresses to the first sub-ending.

Disclosed also is a method of forming a foldable card that includes receiving text for a story, placing portions of the text in triangles and in a pattern such that when the pattern is printed onto a sheet of paper, the paper is foldable into a hexaflexagon. The card includes a first set of six triangles forming a first face in a first flexed orientation of the hexaflexagon, a second set of six triangles forming a second face in a second flexed orientation of the hexaflexagon, and a third set of six triangles forming a third face in a third flexed orientation of the hexaflexagon. The portions of text are selectively oriented on triangles of the first, second, and third sets, such that, when flexed subsequently from the first, to the second, and then to third flexed orientations, the story is progressively conveyed to a user on each of the first, second, and third faces.

A technical contribution for the disclosed method and apparatus is that is provides for a computer implemented method of printing a foldable card, such as greetings cards, story-telling devices, instructional cards, and the like, to form a hexaflexagon.

Embodiments may be interfaced to and controlled by a computer readable medium having stored thereon a computer program. The computer readable medium includes a plurality of components such as one or more of electronic components, hardware components, and/or computer software components. These components may include one or more computer readable media that generally stores instructions such as software, firmware and/or assembly language for performing one or more portions of one or more implementations or embodiments of a sequence. These computer readable media are generally non-transitory and/or tangible. Examples of such a computer readable medium include a recordable data medium of a computer and/or storage device. The computer readable media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of non-transitory and/or tangible computer readable media not list may be employed with embodiments of the invention.

A number of such components can be combined or divided in an implementation of a system. Further, such components may include a set and/or series of computer instructions written in or implemented with any of a number of programming languages, as will be appreciated by those skilled in the art. In addition, other forms of computer readable media such as a carrier wave may be employed to embody a computer data signal representing a sequence of instructions that when executed by one or more computers causes the one or more computers to perform one or more portions of one or more implementations or embodiments of a sequence.

According to one embodiment, a foldable card includes a plurality of triangles connected side-to-side in a planar material, foldable into a hexaflexagon. The card includes a first set of six triangles forming a first face in a first flexed orientation of the hexaflexagon, a second set of six triangles forming a second face in a second flexed orientation of the hexaflexagon, and a third set of six triangles forming a third face in a third flexed orientation of the hexaflexagon. Print on the planar material is selectively oriented on triangles of the first, second, and third faces, such that, when flexed subsequently from the first, to the second, and then to third flexed orientations, a story is progressively conveyed to a user on each of the first, second, and third faces.

According to another embodiment, a computer readable storage medium having stored thereon a computer program comprising instructions, which, when executed by a computer, cause the computer to receive text for a story, and place portions of the text in triangles and in a pattern such that when the pattern is printed onto a sheet of paper, the paper is foldable into a hexaflexagon. The card includes a first set of six triangles forming a first face in a first flexed orientation of the hexaflexagon, a second set of six triangles forming a second face in a second flexed orientation of the hexaflexagon, and a third set of six triangles forming a third face in a third flexed orientation of the hexaflexagon. The portions of text are selectively oriented on triangles of the first, second, and third faces, such that, when flexed subsequently from the first, to the second, and then to third flexed orientations, the story is progressively conveyed to a user on each of the first, second, and third faces.

According to yet another embodiment, a foldable card includes a plurality of triangles connected side-to-side in a planar material, folded into a hexagonally shaped hexaflexagon. The card includes print on the planar material that is selectively oriented on triangles of first, second, and third sets of triangles, such that, when flexed subsequently from first, to second, and then to third flexed orientations, a story is progressively conveyed to a user on each of first, second, and third faces that correspond with the respective first, second, and third flexed orientations.

When introducing elements of various embodiments, the articles “a,” “an,” “the,” and “said” are intended to mean that there are one or more of the elements. The terms “comprising,” “including,” and “having” are intended to be inclusive and mean that there may be additional elements other than the listed elements. Furthermore, any numerical examples in the following discussion are intended to be non-limiting, and thus additional numerical values, ranges, and percentages are within the scope of the disclosed embodiments.

While the disclosed subject matter has been described in detail in connection with only a limited number of embodiments, it should be readily understood that the disclosed subject matter is not limited to such disclosed embodiments. Rather, that disclosed can be modified to incorporate any number of variations, alterations, substitutions or equivalent arrangements not heretofore described, but which are commensurate with the spirit and scope of the disclosed subject matter. Additionally, while various embodiments have been described, it is to be understood that disclosed aspects may include only some of the described embodiments. Accordingly, that disclosed is not to be seen as limited by the foregoing description, but is only limited by the scope of the appended claims.

1. A foldable card, comprising:
a plurality of triangles connected side-to-side in a planar material, foldable into a hexaflexagon, the card including:
a first set of six triangles forming a first face in a first flexed orientation of the hexaflexagon;
a second set of six triangles forming a second face in a second flexed orientation of the hexaflexagon; and
a third set of six triangles forming a third face in a third flexed orientation of the hexaflexagon;
wherein print on the planar material is selectively oriented on triangles of the first, second, and third faces, such that, when flexed subsequently from the first, to the second, and then to third flexed orientations, a story is progressively conveyed to a user on each of the first, second, and third faces;
wherein the first face includes a center at an apex of the first set of six triangles, and the story progresses from a beginning to a first sub-ending, on the first face, with the following steps:
the user orients the first face such that the story is discernible to the user on the first triangle of the first set of triangles; and
the user rotates the first face about the center such that, at subsequent rotational orientations of the first face, the story progresses to the first sub-ending;
wherein the foldable card includes the story on three flexed orientations.

2. (canceled)

3. (canceled)

4. The foldable card of claim 1, wherein, upon flexing to the second flexed orientation and then to the third flexed orientation, the story progresses on the second face and on the third face when the user rotates respectively about each respective center.

5. The foldable card of claim 4, wherein the print is oriented on each triangle such that the story begins from an outer edge of the first face and progresses toward the center.

6. The foldable card of claim 4, wherein the print is oriented on each triangle such that text of the story is approximately orthogonal to each respective center.

7. The foldable card of claim 1, wherein the story includes:
on the first face and in the first flexed orientation:
the beginning of the story on a first triangle of the first set of six triangles; and
the first sub-ending on a second triangle of the first set of six triangles;
on the second face and in the second flexed orientation:
a first continuation of the story, from the first sub-ending, on a first triangle of the second set of six triangles; and
a second sub-ending of the story on a second triangle of the second set of six triangles; and
on the third face and in the third flexed orientation:
a second continuation of the story, from the second sub-ending, on a first triangle of the third set of six triangles; and
a third sub-ending of the story on a second triangle of the third set of six triangles.

8. The foldable card of claim 1, wherein the story is one of:
a fictional narrative;
a non-fictional narrative; and
a greeting for a greeting card.

9. The foldable card of claim 1, wherein the story on at least one of the triangles includes an instruction to perform a task.

10. A method of forming a foldable card, comprising:
placing portions of text in triangles and in a pattern such that when the pattern is printed onto a sheet of paper, the paper is foldable into a hexaflexagon, the card including:
a first set of six triangles forming a first face in a first flexed orientation of the hexaflexagon;
a second set of six triangles forming a second face in a second flexed orientation of the hexaflexagon; and
a third set of six triangles forming a third face in a third flexed orientation of the hexaflexagon; and
selectively orienting portions of text on triangles of the first, second, and third sets, such that, when flexed subsequently from the first, to the second, and then to third flexed orientations, the story is progressively conveyed to a user on each of the first, second, and third faces;
wherein the first face includes a center at an apex of the first set of six triangles, and the story progresses from a beginning to a first sub-ending, on the first face, with the following steps:
orienting the first face such that the story is discernible to the user on the first triangle of the first set of triangles; and
rotating the first face about the center such that, at subsequent rotational orientations of the first face, the story progresses to the first sub-ending;
wherein the foldable card includes the story on three flexed orientations.

11. The method of claim 10, further comprising receiving the story via a keyboard.

12. (canceled)

13. (canceled)

14. The method of claim 10, wherein, upon flexing to the second flexed orientation and then to the third flexed orientation, the story progresses on the second face and on the third face when the user rotates respectively each respective center.

15. The method of claim 14, further comprising orienting the print on each triangle such that the story begins from an outer edge of the first face and progresses toward the center.

16. The method of claim 14, further comprising orienting the print on each triangle such that text of the story is approximately orthogonal to each respective center.

17. The method of claim 10, wherein the story includes:
on the first face and in the first flexed orientation:
the beginning of the story on a first triangle of the first set of six triangles; and
the first sub-ending on a second triangle of the first set of six triangles;
on the second face and in the second flexed orientation:
a first continuation of the story, from the first sub-ending, on a first triangle of the second set of six triangles; and
a second sub-ending of the story on a second triangle of the second set of six triangles; and
on the third face and in the third flexed orientation:
a second continuation of the progressive pattern, from the second sub-ending, on a first triangle of the third set of six triangles; and
a third sub-ending of the story on a second triangle of the third set of six triangles.

18. The method of claim 10, wherein the story is one of:
a fictional narrative;
a non-fictional narrative; and
a greeting for a greeting card.

19. The method of claim 10, wherein the story on at least one of the triangles includes an instruction to perform a task.

20. A foldable card, comprising:
a plurality of triangles connected side-to-side in a planar material, folded into a hexagonally shaped hexaflexagon, the card including:
print on the planar material that is selectively oriented on triangles of first, second, and third sets of triangles, such that, when flexed subsequently from first, to second, and then to third flexed orientations, a story is progressively conveyed to a user on each of first, second, and third faces that correspond with the respective first, second, and third flexed orientations.
